(19) United States
(12) Patent Application Publication
(10) Pub. No.: US 2005/0116403 A1
(43) Pub. Date: Jun. 2, 2005

(54) Composite torsion vibration damper

(76) Inventor: Scott A. Wellman, Plymouth, MI (US)

Correspondence Address: HARNESS, DICKEY & PIERCE, P.L.C., P.O. BOX 828, BLOOMFIELD HILLS, MI, 48303, US

(21) Appl. No.: 10/994,203

(22) Filed: Nov. 19, 2004

Related U.S. Application Data
(60) Provisional application No. 60/523,962, filed on Nov. 21, 2003.

(51) Int. Cl. F16D 13/68

(52) U.S. Cl. 267/279; 267/280

(57) ABSTRACT

A composite torsional vibration damper is disclosed. The torsional vibration damper has a first central hub region and a plurality of radially disposed composite arms. A cylindrical mass is coupled to and annularly disposed about the composite arms. The composite arms are tuned to form composite springs having specific radial stiffness and damping properties.

### CROSS-REFERENCE TO RELATED APPLICATIONS

This application claims the benefit of U.S. Provisional Application No. 60/523,962, filed on Nov. 21, 2003. The disclosure of the above application is incorporated herein by reference.

### FIELD OF THE INVENTION

The present invention relates to torsion vibration dampers and particularly to a torsion vibration damper formed of engineered composite materials.

### BACKGROUND OF THE INVENTION

It is known to use substantially flange-like vibration damper components which can be used for the reduction of torsional stresses or vibrations in drive trains. The devices contain energy storing devices typically in the form of coiled springs which serve to resist or reduce torsional vibration in a rotating structure. In this regard, a torsional vibration damper traditionally has a predetermined and engineered torsional vibration resonant frequency defined by the spring rate of the coiled springs and an associated coupled mass.

It is known that due to stresses in the vibration damping apparatus as described above, certain failure modes are observed. These failure modes include the wear of spring components as well as a substantial amount of wear in the chambers holding these components. This wear reduces the efficiency and durability of the springs and holding chambers as well as leads to noise and potential catastrophic failure of the internal components.

### SUMMARY OF THE INVENTION

In view of the aforementioned problems, it is an object of the current invention to provide a torsional vibration damper which overcomes the deficiencies of prior art systems.

The invention described herein is embodied in an apparatus for damping vibrations in a power train. The torsional vibration damper is formed of a first member having a shaft coupling aperture. The first member is formed of a composite material. A plurality of radially disposed composite arms are coupled directly to the first member. A cylindrical mass is coupled to a second end of these composite arms. The damper is configured to be rotated with a rotatable shaft to dampen torsional vibrations on the shaft.

In another embodiment of the present invention, a torsional vibration damper is formed of a reinforced composite hub. A plurality of composite arms are radially disposed about the hub and coupled to a reinforced thermoplastic cylindrical mass supporting member which in turn is disposed about the composite arms. The mass supporting member encapsulates at least one metallic mass which functions as a mass for the spring mass system.

In another embodiment of the present invention, a torsion vibration damper is formed having a shaft coupling member formed of reinforced composite materials. A plurality of radially disposed composite arms is coupled to the shaft coupling member. An elastomeric layer is disposed annularly about the composite arms. A cylindrical mass is coupled to the elastomeric material.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 represents a composite torsion vibration damper according to the teachings of the present invention;

FIGS. 2A-2E represent a number of cross-sectional views of arms configured to be used in the vibration damper shown in FIG. 1; and

FIG. 3 represents an alternate torsion vibration damper according to the teachings of the present invention.

### DETAILED DESCRIPTION OF THE PREFERRED EMBODIMENTS

The following description of the preferred embodiments is merely exemplary in nature and is in no way intended to limit the invention, its application, or uses.

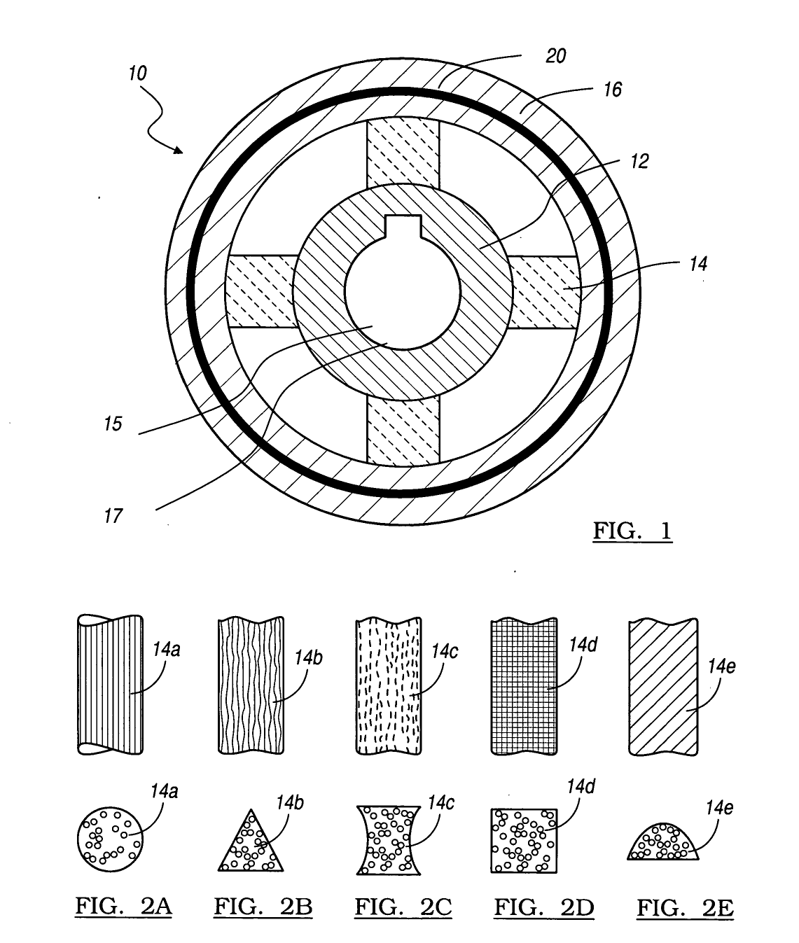

FIG. 1 represents a torsion vibration damper 10 according to the teachings of the present invention. The damper 10 has a central hub 12, plurality of composite arms 14, and surrounding mass supporting member 16. Each of these members a preferably formed of a polymer such as a reinforced thermoset epoxy material.

In this regard, the thermoset epoxy material is preferably reinforced with materials such as E-glass, S-glass, graphite, chopped fibers, continuous long fibers, woven and stitched mat materials, and foam or combinations thereof. It is specifically envisioned that pre-preg material can be used to form the load bearing areas while chopped fibers can be used to reinforce more structural elements.

The hub 12 defines a shaft coupling aperture 15 which is optionally reinforced with a metallic bearing sleeve 17. The aperture 15, which can be formed during the molding process, can be tapered, keyed, or cylindrical as needed by the specific application. Radially disposed about the hub 12 are the composite arms 14. These arms are configured to have a predetermined flexural and radial stiffnesses, which when combined with their length define a plurality of composite springs. These springs couple the mass supporting member 16 to the central hub 12.

The combination of a mass 20 incorporated within the mass supporting member 16 (as described below) and the composite arms 14 provide a torsional vibration damper having an engineering torsional natural frequency and torsional damping coefficient. As best seen in FIGS. 2A-2E, the composite arms 14 can have cross-sectional shapes of round, square, hexagonal, octagon, half-moon, or parabolic. The shape and length of these arms are critical to the tuning of these composite spring members. As with the hub 12, it is envisioned that the arms have strategically placed reinforcement phases. When in form of long fibers, the premolding lay up of the reinforcement phase is of extreme importance to achieve the overall performance characteristics of the finished damper. While the reinforcement phase often naturally comes in a free state form or precoated as pre-preg, care must be taken when building the preforms to keep tension on the reinforcement phase. The tension applied to these fibers allows for a “pre-stress” of the material. The amount of pre-stress can be determined by the products specific performance characteristic targets and its relationship to the yield stress of the material used in the application. This pre-stress occurs prior to the setting or curing of the associated thermoset resin.

This pre-tensioning of the material allows a desire to design in dynamically characteristics of the durability or life cycle longevity of a product. While the pre-stressing is optional, it is envisioned that the torsion vibration damper can be formed using non pre-stressed or optionally compressed reinforcement phases.

While it is envisioned that any number of arms of can be used, preferably the system would be either three arms radially disposed about a central axis 120° from each other, or four arms radially disposed at about 90°. To increase the system stiffness, it is envisioned that each of these arms could be coupled by a webbing material 22 between the arms. Additionally, it is envisioned that the areas between the arms could encapsulate foam components.

The geometry of each arm can be varied within the molded component to add additional flexibility and tuning. Varying the arm geometries along their length can change the characteristic of the spring rate as a function of the loads being applied. In this regard, not only the material buildup in both the loaded and unloading condition can be used for when engine RPM's increase or decrease. It is envisioned that this could be helpful for balancing out gas forces for added numbers of cylinders and in-line engines, i.e. three or five cylinder engines, or in electric engines which utilize controllers for adapting torque and output.

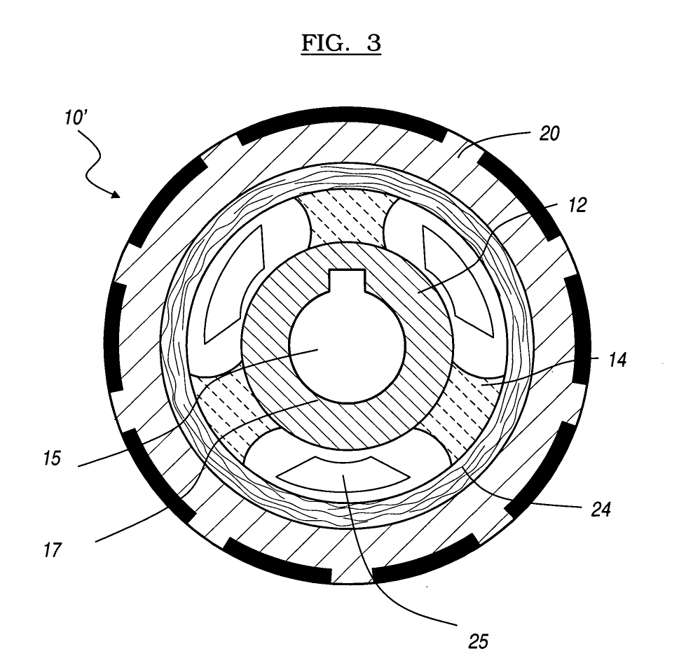

The mass supporting member 16 holds an encapsulated mass 20 in the form of an inertia ring. It is preferred that the mass supporting member 16 completely cover the mass 20 with enough material to reliably fix the mass 20 to the hub 12. The mass 20 can be a solid ring or, as shown in FIG. 3, can be distributed weight radially located about the mass supporting member 20. Optionally, the mass can define an outer surface of the torsion vibration damper 20 so that post-processing machining to balance and tune the damper is possible. Alternatively, the exterior surface of the damper can have in-molded features such as serpentine belt grooves. These grooves can be formed and defined within a surface of the mold that the composite is formed in.

With reference to FIG. 3, it is envisioned that the composite torsion vibration damper 10′ can have a layer of elastomer 24 disposed between the composite arms 14 and the mass supporting member 16. The positioning of the elastomeric material along the surface allows an engineer to further tune the response of the damper 10′ to the requirements of the system.

It is envisioned that the dampers can be formed in a single mold as a monolithic structure. The raw material preforms for this component are placed into a heated or ambient temperature mold and then cured for a specific amount of time based upon the type of resin and cure system selected for the specific application. Pre-stressing or tensioning of the material for each of the components making up the whole is engineered into each specific application. After the molding of the component, the damper 10 is cleaned, deflashed, and spin tuned for a natural frequency in much the same way traditional torsion vibration dampers are today.

The ratio of the mass to the radial stiffness of the composite arms is critical to the overall natural frequency performance of the component and is tunable throughout a frequency range depending on how this ratio changes. While different material selection and cross-sectional geometries of the arms will dictate the stiffness of their structural makeup, not all the same material would be used throughout the damper. In this regard, the system is provided which allows for tuning flexibility in both the loading (engine torque through acceleration) and unloading conditions by providing separate stiffness characteristics depending on whether the damper is being rotationally accelerated or decelerated.

Some sections will predominantly be made up of a mixture of resin-chopped fibers that have a ratio from 70/30% resin to chop fiber mixture to a 30/70% mixture. The additional use of uni-directional fibers to reinforce the hub to the arms to the inertia mass will affect the performance characteristics of the damper. The unidirectional fibers will see both tensile and shear stresses when the damper is in a working cycle. It is envisioned that the volume fraction of uni-directional fibers will range from 30% to 80% fiber to resin based on the location of the design's cross-section. A combination of unidirectional fibers, mat sections, woven and chopped mixture is necessary to bind all the critical geometric aspects of the design together.

As previously mentioned, it is envisioned that within the material makeup of the cross-sections of the composite arms, a medium to high density foam agent can be utilized. This foam is usable in applications where high levels of damping are necessary and cannot be accomplished by material properties of the resin and individual fibers themselves. In this regard, the pre-cut foam sections are treated generally in the same way as an insert component. These foam preform shapes 25 are then wrapped with fiber reinforced pre-preg in much the same way as an inertia mass is encased. The foam then provides an increased damping as the damper is tuned for a specific natural frequency. The foam additionally adds an element which reduces the overall weight of the composite torsion vibration damper.

In the event an elastomer 24 is chosen to achieve the performance characteristics, the formation torsion vibration damper follows the same engineering manufacturing processes as described above. Allowance, of course, is made either in the mold or inserted in a cross-section within the body of the composite vibration torsion damper 10′ which will allow for static or dynamic deflection both radially and axially. The results seen from the elastomer 24 allow for additional deflective, damping, or spring rate characteristics to be achievable across the specific load or frequency range.

The description of the invention is merely exemplary in nature and, thus, variations that do not depart from the gist of the invention are intended to be within the scope of the invention. Such variations are not to be regarded as a departure from the spirit and scope of the invention.

1. A torsion vibration damper comprising:
a first member defining a shaft coupling aperture, said first member formed of a reinforced thermoplastic material;
a plurality of radially disposed composite arms, said composite arms having a first end coupled to the first member;
a cylindrical mass coupled to a second end of the composite arms, wherein the damper is configured to be rotated with a rotating shaft and to dampen rotational vibrations of the shaft.

2. The torsion vibration damper according to claim 1 wherein the cylindrical mass comprises a reinforced thermoset material.

3. The torsion vibration damper according to claim 1 wherein the radially disposed composite arms have a cross-sections selected from the group consisting of a square, a rectangle, a cross, a circle, a hexagonal, and diagonal.

4. The torsion vibration damper according to claim 1 wherein the composite arms comprise radially prestressed reinforcement fibers.

5. The torsion vibration damper according to claim 1 wherein the composite arms have a predetermined radially stiffness and damping coefficient.

6. The torsion vibration damper according to claim 1 wherein the composite arms comprise a foam preform shape.

7. The torsion vibration damper according to claim 1 wherein the composite arms comprise reinforcement fibers selected from the group of E-glass, S-glass, graphite, chopped fibers, continuous fiber, woven fibers, stitched mat, or combinations thereof.

8. The torsion vibration damper according to claim 1 wherein the first member comprises reinforcement fibers selected from the group of E-glass, S-glass, graphite, chopped fibers, continuous fiber, woven fibers, stitched mat, or combinations thereof.

9. A torsion vibration damper comprising:
a first reinforced composite member defining a shaft coupling aperture;
a plurality of radially disposed composite arms coupled to the first member having a predefined stiffness; and
a cylindrical mass comprising a reinforced thermoplastic member coupled to the radially disposed composite arms.

10. The torsion vibration damper according to claim 9 comprising three radially disposed composite arms distributed at 120° intervals about a main axis.

11. The torsion vibration damper according to claim 9 wherein the cylindrical mass is an inertia ring encapsulated within a thermoset resin shell.

12. The torsion vibration damper according to claim 9 wherein the radially disposed composite arms comprise 30% to 70% by weight thermoplastic resin.

13. The torsion vibration damper according to claim 12 wherein the radially disposed composite arms comprise from 30% to 70% by weight reinforced fiber.

14. The torsion vibration damper according to claim 9 wherein the composite arms comprise foam.

15. The torsion vibration damper according to claim 9 wherein the composite arm has a predetermined spring rate.

16. A torsion vibration damper comprising:
a reinforced composite hub;
a plurality of composite arms radially disposed about the reinforced composite hub; and
a reinforced thermoplastic cylindrical mass supporting member annularly disposed about the composite arms, said cylindrical mass supporting member encapsulating a metallic member.

17. The torsion vibration damper according to claim 16 wherein the plurality of composite arms have a predefined stiffness.

18. The torsion vibration damper according to claim 16 wherein the composite arms comprise a reinforcement phase selected from the group of E-glass, S-glass, graphite, chopped fibers, continuous fibers, pre-preg material, woven fibers, foam, and combinations thereof.

19. The torsion vibration damper according to claim 18 wherein the cylindrical mass supporting member comprises a reinforcement phase selected from the group of E-glass, S-glass, graphite, chopped fibers, continuous fibers, pre-preg material, woven fibers, foam, and combinations thereof.

20. The torsion vibration damper according to claim 16 further comprising an elastomeric member disposed between the cylindrical mass supporting member and the plurality of composite arms.
